(19) United States
(12) Patent Application Publication
(10) Pub. No.: US 2008/0276963 A1
(43) Pub. Date: Nov. 13, 2008

(54) SENSING OVER SUDS CONDITION TO IMPROVE CLEANING WITH OXIDIZING AGENTS

(75) Inventors: Michael Stephen Hendrickson, St. Joseph, MI (US); Timothy Nicholas Aykroyd, Brookline, MA (US); Joel Adam Luckman, Benton Harbor, MI (US); Colleen M. Doyle, Stevensville, MI (US); Tremitchell Wright, Elkhart, IN (US)

Correspondence Address: WHIRLPOOL PATENTS COMPANY - MD 0750, 500 RENAISSANCE DRIVE - SUITE 102, ST. JOSEPH, MI, 49085, US

(73) Assignee: WHIRLPOOL CORPORATION, BENTON HARBOR, MI (US)

(21) Appl. No.: 11/744,948

(22) Filed: May 7, 2007

(51) Int. Cl. B08B 7/04

(52) U.S. Cl. 134/18

(57) ABSTRACT

A wash cycle used in a clothes washer with a wash zone for receiving a load of fabric defined within a rotating drum having an outer wall. The wash cycle includes a step of dispensing a detergent wash liquor into the wash zone, washing the fabric load in the wash zone with the detergent wash liquor, dispensing an oxidizing agent wash liquor into the wash zone and washing the fabric load in the wash zone with the oxidizing agent wash liquor. The washing steps include steps of sensing for an oversuds condition. If an oversuds condition is detected, steps are undertaken to reduce the oversuds condition during the step of washing the fabric load.

### BACKGROUND OF THE INVENTION

In connection with the use of clothes washers and other fabric washing appliances, consumers are being provided with a wide array of detergents and additives to assist the consumers in removing stains from fabric loads. One class of additives that is becoming popular is oxidizing agents. While the various chemistries available in the market are useful for removing various different types of stains, the wash cycles provided in wash machines have not always taken into account the various additives and optimized the wash cycles to accommodate those detergents and additives.

Although suds detection and removal or reduction is known in regular washing cycles, such as those disclosed in U.S. Pat. Nos. 5,768,730, 6,269,666 and 4,410,329 using standard detergents, there do not appear to be any wash cycles specifically directed to monitoring oversudsing in a wash step utilizing an oxidizing agent wash liquor.

### SUMMARY OF THE INVENTION

In an embodiment of the invention, a wash cycle is provided for a clothes washer in which the clothes washer has a wash zone for receiving a load of fabric defined within a rotating drum having an outer wall. The wash cycle includes a step of dispensing a detergent wash liquor into the wash zone. Another step is washing the fabric load in the wash zone with the detergent wash liquor. Another step is dispensing an oxidizing agent wash liquor into the wash zone. Another step is washing the fabric load in the wash zone with the oxidizing agent wash liquor. The washing steps include steps of sensing for an oversuds condition. If an oversuds condition is detected, steps are undertaken to reduce the oversuds condition during the step of washing the fabric load.

In an embodiment, the step of washing the fabric in the wash zone with the detergent wash liquor occurs prior to the step of washing the fabric in the wash zone with the oxidizing agent wash liquor.

In an embodiment, the step of washing the fabric in the wash zone with the oxidizing agent wash liquor occurs prior to the step of washing the fabric in the wash zone with the detergent wash liquor.

In an embodiment, the steps of reducing the oversuds condition comprise adding an anti-suds solution to the wash liquor. In different embodiments, the anti-suds solution could be one or more of cold water, a surfactant, fine particles, or silicon. Instead of an anti-suds solution, in some embodiments, the suds may be reduced by applying ultrasonic energy or an electric shock to the wash liquor.

In an embodiment, the step of dispensing an oxidizing agent wash liquor, includes incrementally dispensing the oxidizing agent to the wash liquor while continuously sensing for an oversuds condition, and terminating the further addition of the oxidizing agent until the oversuds condition is no longer sensed.

In an embodiment, the steps of reducing the oversuds condition include tumbling the fabric load in the wash zone by undertaking a low duty cycle intermittent rotation of the washer drum.

In an embodiment, the steps of reducing the oversuds condition include a timed pause in the wash cycle during which time there is no rotation of the washer drum.

In an embodiment, the steps of sensing for the oversuds condition during the washing steps include at least one of sensing an operating condition of a motor used to rotate the drum, the conductivity of the wash liquor, the capacitance of the wash liquor, the surface tension of the wash liquor, the turbidity of the wash liquor and an operating condition of a pump used to circulate the wash liquor.

In an embodiment, the steps of washing the fabric load include recirculating the wash liquor with a recirculation pump and the steps of reducing the oversuds condition include turning off the recirculation pump.

### BRIEF DESCRIPTION OF THE DRAWING

FIG. 1 is a flow chart diagram of a portion of a wash cycle including suds sensing and removal steps.

FIG. 2 is a schematic illustration of a clothes washer in which the steps of the present invention can be carried out.

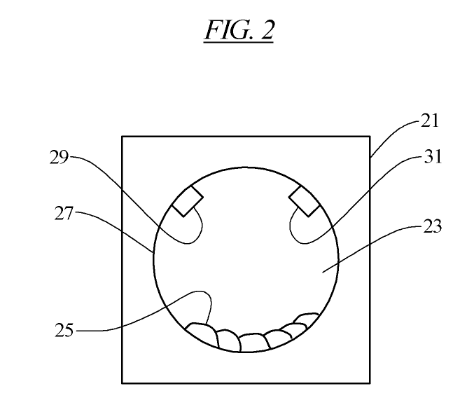

### DETAILED DESCRIPTION OF THE PREFERRED EMBODIMENTS

In an embodiment of the invention, a wash cycle 20 is provided for a clothes washer 21 in which the clothes washer has a wash zone 23 for receiving a load of fabric 25 defined within a rotating drum 27 having an outer wall. The wash cycle includes a step 22 of dispensing a detergent wash liquor via a dispensing outlet 29 into the wash zone 23. Another step 24 is washing the fabric load in the wash zone with the detergent wash liquor. Another step 26 is dispensing an oxidizing agent wash liquor via a dispensing outlet 31 into the wash zone 23. The dispensing outlet 29 for the detergent wash liquor may be the same or different than the dispensing outlet 31 for the oxidizing agent wash liquor. Another step 28 is washing the fabric load in the wash zone 23 with the oxidizing agent wash liquor. The washing steps include steps 30 of sensing for an oversuds condition. If an oversuds condition is detected, steps 34 are undertaken to reduce or remove the oversuds condition during the step of washing the fabric load.

The oxidizing agents to be added to the wash zone are active oxygen releasing compounds, e.g., peroxides (peroxygen compounds) such as perborate, percarbonates, perphosphates, persilicates, persulfates, their sodium, ammonium, potassium and lithium analogs, calcium peroxide, zinc peroxide, sodium peroxide, carbamide peroxide, hydrogen peroxide, and the like. These agents also include peroxy acids and organic peroxides and various mixtures thereof.

A peroxy acid is an acid in which an acidic —OH group has been replaced by an —OOH group. They are formed chiefly by elements in groups 14, 15 and 16 of the periodic table, but boron and certain transition elements are also known to form peroxy acids. Sulfur and phosphorus form the largest range of peroxy acids, including some condensed forms such as peroxydiphosphoric acid, H₄P₂O₈ and peroxydisulfuric acid, H₂S₂O₈. This term also includes compounds such as peroxy-carboxylic acids and meta-chloroperoxybenzoic acid (mCPBA).

Organic peroxides are organic compounds containing the peroxide functional group (ROOR′). If the R′ is hydrogen, the compound is called an organic hydroperoxide. Peresters have general structure RC(O)OOR. The O—O bond easily breaks and forms free radicals of the form RO.. This makes organic peroxides useful for cleaning purposes.

There are four possible descriptions of the oxidizing agent product composition based on concentration. “Ultra concentrated” means that 80 to 100% of the bleach is active. “Concentrated” means that 40 to 79% of the bleach is active. “Bleach with additive” means that 20-40% of the bleach is active. “Cleaning product with bleach” means that less than 25% of the bleach is active.

Oxidizing agents may be combined within a mixture that has a selection of other material, such as one or more of the following: builders, surfactants, enzymes, bleach activators, bleach catalysts, bleach boosters, alkalinity sources, antibacterial agents, colorants, perfumes, pro-perfumes, finishing aids, lime soap dispersants, composition malodor control agents, odor neutralizers, polymeric dye transfer inhibiting agents, crystal growth inhibitors, photobleaches, heavy metal ion sequestrants, anti-tarnishing agents, anti-microbial agents, anti-oxidants, linkers, anti-redeposition agents, electrolytes, pH modifiers, thickeners, abrasives, divalent or trivalent ions, metal ion salts, enzyme stabilizers, corrosion inhibitors, diamines or polyamines and/or their alkoxylates, suds stabilizing polymers, solvents, process aids, fabric softening agents, optical brighteners, hydrotropes, suds or foam suppressors, suds or foam boosters, fabric softeners, antistatic agents, dye fixatives, dye abrasion inhibitors, anti-crocking agents, wrinkle reduction agents, wrinkle resistance agents, soil release polymers, soil repellency agents, sunscreen agents, anti-fade agents, water soluble polymers, water swellable polymers and mixtures thereof.

A particular oxidizing agent to be added to form the oxidizing agent wash liquor could comprise a combination of water with one or more of sodium carbonate, sodium percarbonate, surfactants and enzymes.

In an embodiment, the steps 30 of sensing for the oversuds condition during the washing steps 24, 28 include at least one of sensing an operating condition of a motor used to rotate the drum, the conductivity of the wash liquor, the capacitance of the wash liquor, the surface tension of the wash liquor, the turbidity of the wash liquor and an operating condition of a pump used to circulate or recirculated the wash liquor.

In an embodiment, the step 24 of washing the fabric load 25 in the wash zone with the detergent wash liquor occurs prior to the step 28 of washing the fabric in the wash zone with the oxidizing agent wash liquor.

In an embodiment, the step 24 of washing the fabric load 25 in the wash zone with the oxidizing agent wash liquor occurs prior to the step 28 of washing the fabric in the wash zone with the detergent wash liquor.

In an embodiment, the steps 34 of removing or reducing the oversuds condition comprise a step 36 of adding an anti-suds treatment, such as a solution to the wash liquor. In different embodiments, the anti-suds solution could be one or more of cold water, a surfactant, fine particles, or silicon. Instead of an anti-suds solution, in some embodiments, the suds may be removed or reduced by a treatment such as applying ultrasonic energy or an electric shock to the wash liquor.

In an embodiment, the steps 34 of reducing the oversuds condition may include a step 38 of tumbling the fabric load in the wash zone 23 by undertaking a low duty cycle intermittent rotation of the washer drum 27.

In an embodiment, the steps 34 of reducing the oversuds condition may include a step 40 of a timed pause in the wash cycle during which time there is no rotation of the washer drum 27.

In an embodiment, the steps 24, 28 of washing the fabric load 25 include recirculating the wash liquor with a recirculation pump and the steps 34 of reducing the oversuds condition include turning off the recirculation pump.

Upon the completion of the steps 34 of reducing the oversuds condition, a step 42 is preformed to return control back to the regular wash cycle 20 to resume the normal washing steps.

For example, after the step 24 of washing the fabric load 25 in the detergent wash liquor, the control determines in step 44 whether the particular wash cycle selects an oxidizing agent. A step 46 is then carried out to determine whether an additional amount of oxidizing agent is needed.

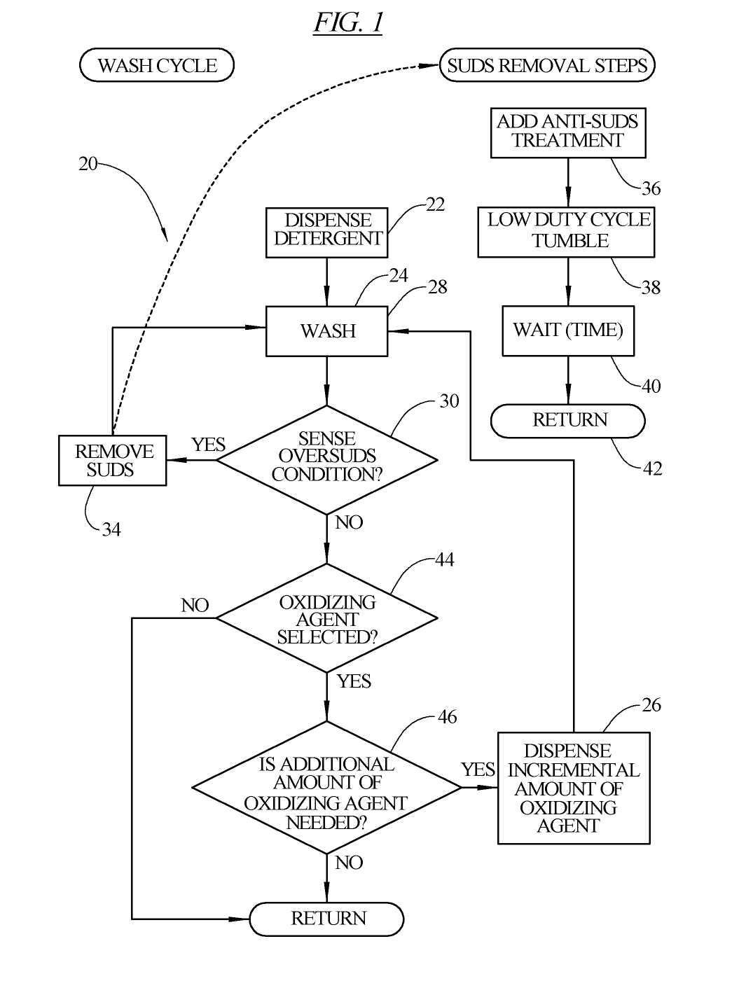

In an embodiment, the step 26 of dispensing an oxidizing agent wash liquor, includes incrementally dispensing the oxidizing agent to the wash liquor while continuously sensing in step 30 for an oversuds condition, and terminating the further addition of the oxidizing agent until the oversuds condition is no longer sensed. As shown in FIG. 1, during a first time through the various steps, in step 44, it would be determined that an oxidizing agent has been selected. In step 46, it would be determined that an additional amount of oxidizing agent is needed, since none would have been added yet. In step 26, an incremental amount of oxidizing agent is added to the wash zone 23 and the step 28 of washing the fabric load 25 would begin. The oversuds condition would be sensed in step 30, and if oversudsing is sensed, then the steps 34-40 of removing or reducing the suds would be carried out.

The wash cycle 28 would be resumed and the oversuds condition would be checked again in step 30. If oversudsing is detected again, control would return to the suds removal steps 34-40, but if oversudsing is no longer detected, then control would pass to step 44 to determine, again, if an oxidizing agent was selected and then to step 46 to determine whether additional oxidizing agent is needed. If a further incremental amount of oxidizing agent is needed, then control passes again to step 26 to dispense a further amount of oxidizing agent and then to step 28 to continue the washing in the oxidizing agent wash liquor, while continuing to sense the oversuds condition in step 44.

Various features of the wash cycle 20 and suds sensing and removal steps have been described which may be incorporated singly or in various combinations into a desired system, even though only certain combinations are described herein. The described combinations should not be viewed in a limiting way, but only as illustrative examples of particular possible combinations of features.

As is apparent from the foregoing specification, the invention is susceptible of being embodied with various alterations and modifications which may differ particularly from those that have been described in the preceding specification and description. It should be understood that we wish to embody within the scope of the patent warranted hereon all such modifications as reasonably and properly come within the scope of our contribution to the art.

1. A wash cycle for a clothes washer, the clothes washer having a wash zone defined within a rotating drum having an outer wall, for receiving a load of fabric, comprising the steps:
dispensing a detergent wash liquor into the wash zone,
washing the fabric load in the wash zone with the detergent wash liquor,
dispensing an oxidizing agent wash liquor into the wash zone,
washing the fabric load in the wash zone with the oxidizing agent wash liquor,
wherein the washing steps include sensing for an oversuds condition, and if an oversuds condition is detected, undertaking steps to reduce the oversuds condition during the step of washing the fabric load.

2. The wash cycle of claim 1, wherein the step of washing the fabric in the wash zone with the detergent wash liquor occurs prior to the step of washing the fabric in the wash zone with the oxidizing agent wash liquor.

3. The wash cycle of claim 1, wherein the step of washing the fabric in the wash zone with the oxidizing agent wash liquor occurs prior to the step of washing the fabric in the wash zone with the detergent wash liquor.

4. The wash cycle of claim 1, wherein the steps of reducing the oversuds condition comprise adding an anti-suds solution to the wash liquor.

5. The wash cycle of claim 4, wherein the anti-suds solution comprises cold water.

6. The wash cycle of claim 4, wherein the anti-suds solution comprises a surfactant.

7. The wash cycle of claim 4, wherein the anti-suds solution comprises fine particles.

8. The wash cycle of claim 4, wherein the anti-suds solution comprises silicon.

9. The wash cycle of claim 1, wherein the steps of reducing the oversuds condition comprise applying ultrasonic energy to the wash liquor.

10. The wash cycle of claim 1, wherein the steps of reducing the oversuds condition comprise applying an electric shock to the wash liquor.

11. The wash cycle of claim 1, wherein the step of dispensing an oxidizing agent wash liquor, comprises incrementally dispensing the oxidizing agent to the wash liquor while continuously sensing for an oversuds condition, and terminating the further addition of the oxidizing agent until the oversuds condition is no longer sensed.

12. The wash cycle of claim 1, wherein the steps of reducing the oversuds condition comprise tumbling the fabric load in the wash zone by undertaking a low duty cycle intermittent rotation of the washer drum.

13. The wash cycle of claim 1, wherein the steps of reducing the oversuds condition comprise a timed pause in the wash cycle during which time there is no rotation of the washer drum.

14. The wash cycle of claim 1, wherein the steps of sensing for the oversuds condition during the washing steps comprise at least one of sensing an operating condition of a motor used to rotate the drum, the conductivity of the wash liquor, the capacitance of the wash liquor, the surface tension of the wash liquor, the turbidity of the wash liquor and an operating condition of a pump used to circulate the wash liquor.

15. A wash cycle for a clothes washer, the clothes washer having a wash zone defined within a rotating drum having an outer wall, for receiving a load of fabric, comprising the steps:
dispensing a detergent wash liquor into the wash zone,
washing the fabric load in the wash zone with the detergent wash liquor while sensing for an oversuds condition, and if an oversuds condition is detected, undertaking steps to reduce the oversuds condition during this step of washing the fabric load,
incrementally dispensing an oxidizing agent wash liquor into the wash zone while sensing for an oversuds condition, and if an oversuds condition is detected, undertaking steps to reduce the oversuds condition during this step of washing the fabric load, and if no oversuds condition is detected, continuing to incrementally dispense the oxidizing agent until a desired amount of oxidizing agent is added to the oxidizing agent wash liquor,
the steps of reducing the oversuds condition comprise adding an anti-suds treatment to the wash liquor, tumbling the fabric load in the wash zone by undertaking a low duty cycle intermittent rotation of the washer drum, and thereafter, undertaking a timed pause in the wash cycle during which time there is no rotation of the washer drum, prior to returning to the step of washing the fabric load.

16. The wash cycle of claim 15, wherein the step of washing the fabric in the wash zone with the detergent wash liquor occurs prior to the step of washing the fabric in the wash zone with the oxidizing agent wash liquor.

17. The wash cycle of claim 15, wherein the step of washing the fabric in the wash zone with the oxidizing agent wash liquor occurs prior to the step of washing the fabric in the wash zone with the detergent wash liquor.

18. The wash cycle of claim 1, wherein the step of adding an anti-suds treatment to the wash liquor comprises at least one of adding cold water, adding a surfactant, adding fine particles, adding silicon, applying ultrasonic energy and applying an electric shock to the wash liquor.

19. The wash cycle of claim 1, wherein the steps of sensing for the oversuds condition during the washing steps comprise at least one of sensing an operating condition of a motor used to rotate the drum, the conductivity of the wash liquor, the capacitance of the wash liquor, the surface tension of the wash liquor, the turbidity of the wash liquor and an operating condition of a pump used to circulate the wash liquor.
